(19) United States
(12) Patent Application Publication
(10) Pub. No.: US 2023/0113629 A1
(43) Pub. Date: Apr. 13, 2023

(54) Tag Identification And Inventory Method And Apparatus, Reader, Medium And Computer Program

(71) Applicant: Siemens Aktiengesellschaft, München (DE)

(72) Inventor: Xiao Dong Deng, Beijing (CN)

(73) Assignee: Siemens Aktiengesellschaft, München (DE)

(21) Appl. No.: 17/914,269

(22) PCT Filed: Mar. 24, 2020
(86) PCT No.: PCT/CN2020/080872

§ 371 Date: Sep. 23, 2022

(51) Int. Cl. G06K 7/10; G06Q 10/087

(52) U.S. Cl. CPC G06K 7/10029; G06Q 10/087

(57) ABSTRACT

Various embodiments of the teachings herein include a tag identification method. Some embodiments comprise: receiving a tag signal in a time slot; and determining whether a tag collision occurs in the time slot. If a tag collision occurs, the method includes selecting one tag signal from a plurality of received tag signals to identify a corresponding tag and recording a quantity of unidentified tags in the time slot.

### CROSS REFERENCE TO RELATED APPLICATIONS

This application is a U.S. National Stage Application of International Application No. PCT/CN2020/080872 filed Mar. 24, 2020, which designates the United States of America, the contents of which are hereby incorporated by reference in their entirety.

### TECHNICAL FIELD

The present disclosure generally relates to the field of wireless technologies. Various embodiments of the teachings herein may include tag identification and tag inventorying methods and/or apparatus.

### BACKGROUND

Generally, a radio frequency identification (RFID) system includes an RFID tag reading device or reader and one or more RFID tags. The tags are compact and require no onboard power supply, and the tags respond to interrogating signals broadcast by the reader. These tags may obtain some energy from the broadcast interrogating signals for onboard processing, and then backscatter some of the incident energy to transmit information, such as an identifier of the tag, to the reader. Because of a potential small size and low cost of RFID tags, the RFID tags may be attached or placed on various objects such as commodities, vehicles, livestock, wild animals, and ID cards or bracelets. Because each RFID tag may be given a unique identification number, an RFID reader may quickly detect and record each RFID tag within a broadcast and reception range of the reader.

The throughput of tag inventorying is defined as how many tags are inventoried in one inventory round. In the EPCglobal Class 1 Generation 2 air interface protocol (that is, the ISO18000-6C standard) for a reader running at an ultrahigh frequency (UHF), a variant of the time-slotted ALOHA is used for inventory tags. At the beginning of an inventory round, the reader issues a query instruction, including information about a quantity of allocated time slots, and a tag generally replies with a 16-bit random number. Generally, there are several time slots for tags to make responses in the inventory round.

However, the tags generally randomly select one time slot from all available time slots. Time slots are selected based on a quantity of tags, and there are three types of time slots. If only one tag replies in a time slot, the time slot is a successful time slot. If no tag replies in a time slot, the time slot is an empty time slot, and a collision time slot is defined as a time slot in which at least two tags reply. To improve the throughput of tag inventorying, a probability of successful time slots needs to be increased, because the reader may decode a unique identification number in a successful time slot. Theoretically, when durations of the three types of time slots are equal, if a quantity of time slots is equal to a quantity of tags, the tag inventorying efficiency may reach an upper limit of ⅟e.

However, because the quantity of tags is unknown in advance, a quantity of time slots allocated by the reader in the inventory round is generally different from a quantity of tags to be inventoried, which results in low throughput of tag inventorying. To improve the throughput of tag inventorying, at least three possible solutions may be adopted.

Firstly, the quantity of time slots in an inventory round may be adjusted within a dynamic range. The reader may adjust a quantity of time slots in a next inventory round based on a quantity of time slots in which a collision occurs in a current inventory round. More specifically, if the quantity of time slots in which a collision occurs exceeds a threshold, the reader increases the quantity of time slots by one step size. While if a quantity of empty time slots exceeds the threshold, the quantity of time slots is reduced by one step size. An objective of dynamically setting a quantity of time slots in an inventory round is to match the quantity of time slots with a quantity of uninventoried tags. However, actually, it is difficult to correctly adjust a quantity of time slots because it is difficult to map an exact quantity of collision time slots or empty slots with a threshold and a step size that are in a pair.

Secondly, the quantity of time slots in the inventory round is estimated based on a probability. For example, if n represents the quantity of collision time slots, a lower limit of uninventoried tags is 2*n. Furthermore, there are some studies on the estimation of the quantity of uninventoried tags on the basis of the collision time slots. E*n is an example, where E represents an expected quantity of tags in a collision time slot. However, because the estimation of the quantity of uninventoried tags is based on a probability rather than a detection of each collision time slot, the throughput of tag inventorying may be further improved.

Finally, the throughput of tag inventorying may be maximized if the reader can decode all tags that reply in a collision time slot. Currently, there are some studies on parallel tag inventorying, which allows the reader to decode every tag that replies in a collision time slot. However, parallel tag inventorying does not allow the reader to obtain electronic product codes (EPCs) from all collision tags compatible with the ISO18000-6C standard. For example, the reader may decode respective 16-bit random numbers of a tag A and a tag B, but because the reader acknowledges the tag A with the 16-bit random number of the tag A to obtain the EPC of the tag A, the tag B times out in this process. In other words, in the parallel tag inventorying method, the reader cannot obtain the EPCs of the two tags in the collision time slot to identify the two tags respectively. Therefore, the parallel tag inventorying method cannot improve the throughput of tag inventorying.

### SUMMARY

This brief summary is given below to provide a basic understanding of some aspects of the present disclosure. It should be understood that the summary is not an exhaustive summary. The summary is neither intended to determine the key or important part of the present disclosure, nor to limit the scope thereof. The object thereof is merely to give some concepts in a simplified form, as a prelude to the more detailed description presented later. For example, some embodiments include a tag identification method comprising: a tag signal receiving step: receiving a tag signal in a time slot; and a signal processing step: determining whether a tag collision occurs in the time slot, and if it is determined that a tag collision occurs, selecting one tag signal from a plurality of received tag signals to identify a corresponding tag, and recording a quantity of unidentified tags in the time slot.

In some embodiments, if it is determined that no tag collision occurs in a time slot, and when one tag signal is received, identifying a corresponding tag, and recording a quantity of unidentified tags in the time slot as 0; or when no tag signal is received, recording the quantity of unidentified tags in the time slot as 0.

In some embodiments, the method further comprises adding up quantities of unidentified tags recorded in all time slots in one inventory round to obtain a total quantity of unidentified tags in the inventory round, and setting a quantity of time slots in a next inventory round based on the total quantity of unidentified tags.

In some embodiments, the quantity of time slots in the next inventory round is set to be equal to the total quantity of unidentified tags.

In some embodiments, selecting one tag signal from a plurality of received tag signals to identify a corresponding tag comprises: sending an acknowledgement signal for the selected tag signal, and receiving an electronic product code sent by the corresponding tag for identification.

As another example, some embodiments include a tag identification apparatus comprising: a tag signal receiving unit configured to receive a tag signal in a time slot; and a signal processing unit configured to determine whether a tag collision occurs in the time slot, and if it is determined that a tag collision occurs, select one tag signal from a plurality of received tag signals to identify a corresponding tag, and record a quantity of unidentified tags in the time slot.

As another example, some embodiments include a tag inventorying method, comprising: a tag signal receiving step: receiving a plurality of tag signals in a time division manner based on a set quantity of time slots; a successful time slot processing step: identifying a tag corresponding to one tag signal received in each successful time slot in which only the one tag signal is received; a collision time slot determining step: determining whether there is a collision time slot in which a tag collision occurs, and if there is no collision time slot in which a tag collision occurs, ending the method, or if there is a collision time slot in which a tag collision occurs, continuing with the following steps: a collision time slot processing step: selecting one tag signal from a plurality of tag signals received in each collision time slot in which a tag collision occurs, to identify a corresponding tag, and determining a quantity of unidentified tags in the collision time slot; a total unidentified tag quantity determining step: adding up the quantities of unidentified tags in all the collision time slots in one inventory round to obtain a total quantity of unidentified tags in the inventory round; and a cyclic control step: setting a quantity of time slots in a next inventory round based on the determined total quantity of unidentified tags, and performing the steps of the method again from the tag signal receiving step based on the set quantity of time slots.

In some embodiments, the quantity of time slots in the next inventory round is set to be equal to the total quantity of unidentified tags.

In some embodiments, selecting one tag signal from a plurality of received tag signals is implemented in at least one of the following manners: randomly selecting one tag signal, selecting the tag signal with maximum energy, and selecting the tag signal with minimum energy.

In some embodiments, identifying a corresponding tag comprises: sending an acknowledgement signal for the selected tag signal, and receiving an electronic product code sent by the corresponding tag for identification.

As another example, some embodiments include a tag inventorying apparatus, comprising: a tag signal receiving unit configured to receive a plurality of tag signals in a time division manner based on a set quantity of time slots; a successful time slot processing unit configured to identify a tag corresponding to one tag signal received in each successful time slot in which only the one tag signal is received; a collision time slot determining unit configured to determine whether there is a collision time slot in which a tag collision occurs, and if there is no collision time slot in which a tag collision occurs, end the operation, or if there is a collision time slot in which a tag collision occurs, perform operations of the following units: a collision time slot processing unit configured to select one tag signal from a plurality of tag signals received in each collision time slot in which a tag collision occurs, to identify a corresponding tag, and determine a quantity of unidentified tags in the collision time slot; a total unidentified tag quantity determining unit configured to add up the quantities of unidentified tags in all the collision time slots in one inventory round to obtain a total quantity of unidentified tags in the inventory round; and a cyclic control unit configured to set a quantity of time slots in a next inventory round based on the determined total quantity of unidentified tags, and perform, based on the set quantity of time slots, the operation of each unit again from the operation of the tag signal receiving unit.

As another example, some embodiments include a reading device (500), comprising: at least one processor (502); and a memory (504) coupled to the at least one processor (502), wherein the memory is configured to store instructions that, when executed by the at least one processor (502), cause the processor (502) to perform one or more of the methods described herein.

As another example, some embodiments include a non-transitory machine-readable storage medium storing executable instructions that, when executed, cause the machine to perform one or more of the methods as described herein.

As another example, some embodiments include a computer program, comprising computer-executable instructions that, when executed, cause at least one processor to perform one or more of the methods described herein.

As another example, some embodiments include a computer program product tangibly stored on a computer-readable medium, and comprising computer-executable instructions that, when executed, cause at least one processor to perform one or more of the methods as described herein.

### BRIEF DESCRIPTION OF THE DRAWINGS

The foregoing and other objectives, features, and advantages of the teachings of the present disclosure can be more easily understood with reference to the following descriptions of example embodiments in conjunction with the accompanying drawings. Components in the accompanying drawings are merely for illustrating but not limiting the principle of the present disclosure. In the accompanying drawings, same or similar technical features or components are represented by using same or similar reference signs.

FIG. 1 is a flowchart of an exemplary process of a tag identification method incorporating teachings of the present disclosure;

FIG. 2 is a block diagram of an exemplary configuration of a tag identification apparatus incorporating teachings of the present disclosure;

FIG. 3 is a flowchart of an exemplary process of a tag inventorying method incorporating teachings of the present disclosure;

FIG. 4 is a block diagram of an exemplary configuration of a tag inventorying apparatus incorporating teachings of the present disclosure; and

FIG. 5 is a block diagram showing a reading device 500 implementing a tag identification method and a tag inventorying method incorporating teachings of the present disclosure.

### REFERENCE SIGNS

100: tag identification method S101, S102, S103: steps
200: tag identification 201: tag signal receiving unit apparatus
202: signal processing unit 203: time slot quantity setting unit
300: tag inventorying method S301, S302, S303, S304, S305, S306: steps
400: tag inventorying apparatus 401: tag signal receiving unit
402: successful time slot 403: collision time slot processing unit determining unit
404: collision time slot 405: total unidentified tag processing unit quantity determining unit
406: cyclic control unit 500: reading device
502: processor 504: memory

### DETAILED DESCRIPTION OF EMBODIMENTS

Some embodiments of the present disclosure in a tag inventorying method. Unlike probability-based tag estimation, in the tag inventorying methods incorporating teachings of the present disclosure, signals received in each time slot in an inventory round are checked. A method such as parallel tag inventorying may be used to determine a quantity of tags that reply in a time slot, and a parallel decoding method is modified as follows: Only one of the tags that reply in a time slot in which a collision occurs is decoded, and a quantity of the other tags in the time slot is determined without decoding the other collision tags. The reader knows a quantity of undecoded tags at the end of a current inventory round, and sets a quantity of time slots in a next inventory round based on the quantity of undecoded tags, so that the throughput of the next inventory round may be optimized.

In some embodiments, a tag identification method may include: a tag signal receiving step: receiving a tag signal in a time slot; and a signal processing step: determining whether a tag collision occurs in the time slot, and if it is determined that a tag collision occurs, selecting one tag signal from a plurality of received tag signals to identify a corresponding tag, and recording a quantity of unidentified tags in the time slot.

In some embodiments, if it is determined that no tag collision occurs in a time slot, when one tag signal is received, a corresponding tag is identified, and a quantity of unidentified tags in the time slot is recorded as 0; or when no tag signal is received, the quantity of unidentified tags in the time slot is recorded as 0.

In some embodiments, the method further includes: adding up quantities of unidentified tags recorded in all time slots in one inventory round to obtain a total quantity of unidentified tags in the inventory round, and setting a quantity of time slots in a next inventory round based on the total quantity of unidentified tags.

In some embodiments, the quantity of time slots in the next inventory round may be set to be equal to the total quantity of unidentified tags.

In some embodiments, selecting one tag signal from a plurality of received tag signals to identify a corresponding tag includes: sending an acknowledgement signal for the selected tag signal, and receiving an electronic product code sent by the corresponding tag for identification.

In some embodiments, a tag identification apparatus may include: a tag signal receiving unit configured to receive a tag signal in a time slot; and a signal processing unit configured to determine whether a tag collision occurs in the time slot, and if it is determined that a tag collision occurs, select one tag signal from a plurality of received tag signals to identify a corresponding tag, and record a quantity of unidentified tags in the time slot.

In some embodiments, a tag inventorying method may include: a tag signal receiving step: receiving a plurality of tag signals in a time division manner based on a set quantity of time slots; a successful time slot processing step: identifying a tag corresponding to one tag signal received in each successful time slot in which only the one tag signal is received; a collision time slot determining step: determining whether there is a collision time slot in which a tag collision occurs, and if there is no collision time slot in which a tag collision occurs, ending the method, or if there is a collision time slot in which a tag collision occurs, continuing with the following steps: a collision time slot processing step: selecting one tag signal from a plurality of tag signals received in each collision time slot in which a tag collision occurs, to identify a corresponding tag, and determining a quantity of unidentified tags in the collision time slot; a total unidentified tag quantity determining step: adding up the quantities of unidentified tags in all the collision time slots in one inventory round to obtain a total quantity of unidentified tags in the inventory round; and a cyclic control step: setting a quantity of time slots in a next inventory round based on the determined total quantity of unidentified tags, and performing the steps of the method again from the tag signal receiving step based on the set quantity of time slots.

In some embodiments, the quantity of time slots in the next inventory round may be set to be equal to the total quantity of unidentified tags.

In some embodiments, selecting one tag signal from a plurality of received tag signals is implemented in at least one of the following manners: randomly selecting one tag signal, selecting the tag signal with maximum energy, and selecting the tag signal with minimum energy.

In some embodiments, identifying a corresponding tag further includes: sending an acknowledgement signal for the selected tag signal, and receiving an electronic product code sent by the corresponding tag for identification.

In some embodiments, a tag inventorying apparatus may include: a tag signal receiving unit configured to receive a plurality of tag signals in a time division manner based on a set quantity of time slots; a successful time slot processing unit configured to identify a tag corresponding to one tag signal received in each successful time slot in which only the one tag signal is received; a collision time slot determining unit configured to determine whether there is a collision time slot in which a tag collision occurs, and if there is no collision time slot in which a tag collision occurs, end the operation, or if there is a collision time slot in which a tag collision occurs, perform operations of the following units: a collision time slot processing unit configured to select one tag signal from a plurality of tag signals received in each collision time slot in which a tag collision occurs, to identify a corresponding tag, and determine a quantity of unidentified tags in the collision time slot; a total unidentified tag quantity determining unit configured to add up the quantities of unidentified tags in all the collision time slots in one inventory round to obtain a total quantity of unidentified tags in the inventory round; and a cyclic control unit configured to set a quantity of time slots in a next inventory round based on the determined total quantity of unidentified tags, and perform, based on the set quantity of time slots, the operation of each unit again from the operation of the tag signal receiving unit.

In some embodiments, a reading device is provided, including: at least one processor; and a memory coupled to the at least one processor, wherein the memory is configured to store instructions that, when executed by the at least one processor, cause the processor to perform one or more of the methods described herein.

In some embodiments, a non-transitory machine-readable storage medium is provided, which stores executable instructions that, when executed, cause the machine to perform one or more of the methods described herein.

In some embodiments, a computer program is provided, the computer program including computer executable instructions that, when executed, cause at least one processor to perform one or more of the methods described herein.

In some embodiments, a computer program product is provided, which is tangibly stored in a computer-readable medium and includes computer-executable instructions that, when executed, cause at least one processor to perform one or more of the methods described herein.

According to the tag identification method and apparatus and the tag inventorying method and apparatus of the present disclosure, signals received in all time slots of an inventory round are checked, and a parallel tag inventorying method is used to detect a quantity of collision tags, so as to accurately determine a quantity of uninventoried tags.

In some embodiments, a 16-bit random number of one tag from a plurality of tags that collide is selected for acknowledgement, and a corresponding EPC of the tag may be obtained, thereby implementing compatibility with the ISO 18000 6C standard.

In some embodiments, because the quantity of allocated time slots is determined based on the accurate quantity of uninventoried tags, the throughput of tag inventorying may be improved.

In some embodiments, the tag identification method and apparatus and the tag inventorying method and apparatus incorporating teachings of the present disclosure have a high tag inventorying speed, which is a key performance of an RFID reader. Therefore, an RFID reader using the tag inventorying method according to the present disclosure is more advantageous in applications such as gates where huge amounts of moving tags need to be inventoried.

The tag identification methods and apparatus described herein and the tag inventorying method and apparatus are compatible with the ISO 18000 6C standard, and therefore have no additional requirements for tags.

The subject matter described herein is now discussed with reference to exemplary implementations. It should be understood that the discussion of these implementations is merely intended to help a person skilled in the art to better understand and implement the subject matter described herein, but not to limit the scope of protection, applicability or examples set forth. The functions and arrangements of the discussed elements can be changed without departing from the scope of protection of the present disclosure. Various processes or components may be omitted, replaced, or added in various examples as required. For example, the described method may be performed in an order different from the one described, and the steps may be added, omitted, or combined. In addition, the features described in some examples can also be combined in other examples.

As used herein, the term “include” and variants thereof represent an open term, which means “including but not limited to”. The term “based on” represents “at least partially based on”. The terms “an embodiment” and “the embodiment” represent “at least one embodiment”. The term “another embodiment” denotes “at least one other embodiment”. The terms “first”, “second”, and the like may refer to different or the same objects. Other definitions, whether explicit or implicit, can be included below. Unless expressly specified in the context, the definition of a term is consistent throughout the specification.

Different from probability-based tag estimation, in the tag identification method and the tag inventorying method incorporating teachings of the present disclosure, signals received in all time slots in an inventory round are checked. A method such as parallel tag inventorying may be used to determine a quantity of tags that reply in a time slot, and a parallel decoding method is modified as follows: Only a signal of one of the tags that reply in a time slot in which a collision occurs is decoded, and a quantity of the other tag signals in the time slot is determined without decoding the other collision signals. The reader knows a quantity of undecoded tags at the end of a current inventory round, and sets a quantity of time slots in a next inventory round based on the quantity of undecoded tags, so that the throughput of the next inventory round may be optimized.

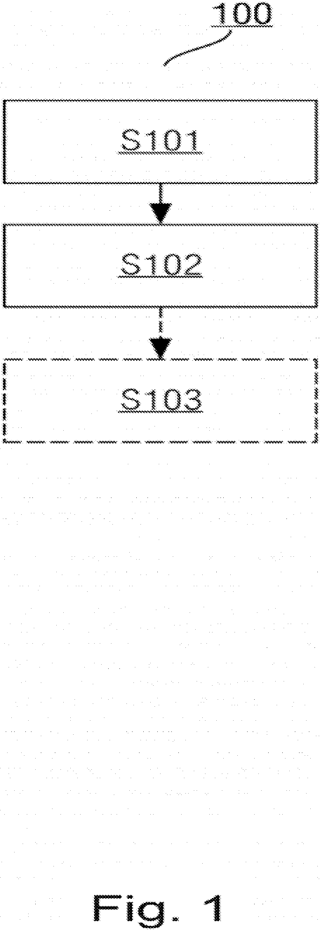

FIG. 1 is a flowchart of an exemplary process of a tag identification method 100 incorporating teachings of the present disclosure. In FIG. 1, a tag signal receiving step in box S101 is first performed, that is, a tag signal is received in a time slot. It may be understood that there may be only one tag in a time slot that replies to a broadcast message of a reader, that is, the reader receives only one tag signal, and such a time slot is called a successful time slot in the specification. Alternatively, there may be no tag in a time slot that replies, that is, the reader receives no tag signal, and such a time slot is called an empty time slot. In some embodiments, there may be a plurality of tags that reply, that is, the reader receives a plurality of tag signals and a tag collision occurs, and such a time slot is called a collision time slot.

Therefore, then a signal processing step in box S102 is performed, that is, whether a tag collision occurs in the time slot is determined; and if it is determined that a tag collision occurs, one tag signal is selected from a plurality of received tag signals to identify a corresponding tag, and a quantity of unidentified tags in the time slot is recorded. Specifically, identifying a corresponding tag includes: sending an acknowledgement signal for the selected tag signal, and receiving an electronic product code sent by the corresponding tag for identification.

For example, in a time slot, a tag collision occurs between a tag A and a tag B, the reader receives a 16-bit random number “RN16A” sent by the tag A and a 16-bit random number “RN16B” sent by the tag B and selects to send an acknowledgement signal “ACK+RN16A” to the tag A, then the tag A sends its electronic product code EPC, and the reader correctly receives the EPC, so as to complete the identification of the tag.

In some embodiments, if it is determined that no tag collision occurs in a time slot, when one tag signal is received, a corresponding tag is identified, and a quantity of unidentified tags in the time slot is recorded as 0; or when no tag signal is received, the quantity of unidentified tags in the time slot is recorded as 0.

In some embodiments, a method such as parallel tag inventorying may be used to determine a quantity of a plurality of tags that collide in a collision time slot. Because one of the plurality of tags is identified, a quantity of unidentified tags in the collision time slot is calculated by subtracting 1 from the determined quantity of tags that collide. Those skilled in the art may understand a specific process of using the parallel tag inventorying method to determine a quantity of tags that collide in a collision time slot and a quantity of unidentified tags in the collision time slot, and details are not described herein again.

In some embodiments, the tag identification method 100 may further include a step in box S103: adding up quantities of unidentified tags recorded in all time slots in one inventory round to obtain a total quantity of unidentified tags in the inventory round, and setting a quantity of time slots in a next inventory round based on the total quantity of unidentified tags. In some embodiments, the quantity of time slots in the next inventory round may be set to be equal to the total quantity of unidentified tags.

Table 1 below shows tag signals received by a reader and a determined quantity of unidentified tags in different types of time slots.

TABLE 1

| | | |
|---|---|---|
| Time Slot Type | Acknowledgment Information of the Reader | Quantity of Unidentified Tags |
| Empty time slot | None | 0 |
| Successful time slot | A 16-bit random number | 0 |
| Collision time slot | A selected 16-bit random number | Actual quantity of unidentified tags, that is, a quantity of collision tags minus 1 |

In the example shown in Table 1, in the empty time slot, the reader receives no random number and determines the quantity of unidentified tags as 0. In the successful time slot, the reader receives a 16-bit random number, identifies a corresponding tag, and determines the quantity of unidentified tags as 0. In the collision time slot, the reader selects a 16-bit random number of a tag signal for acknowledgement, identifies a corresponding tag, and uses the method of parallel tag inventorying to determine and output the quantity of unidentified tags.

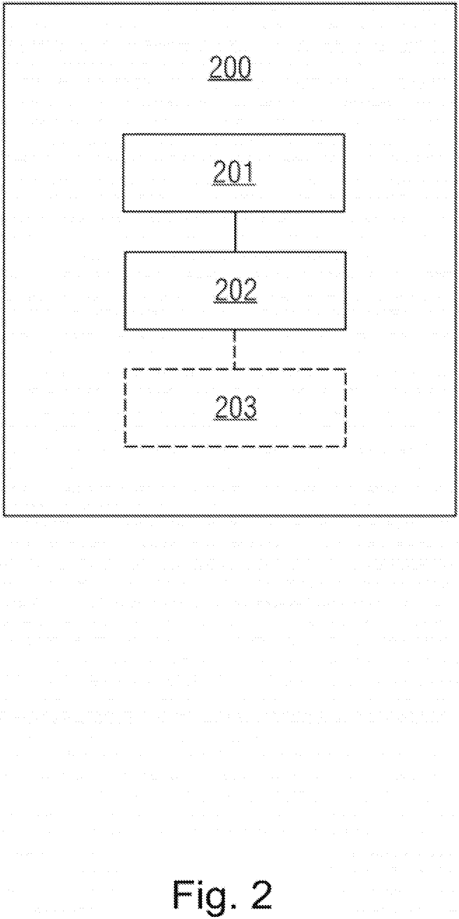

FIG. 2 is a block diagram of an exemplary configuration of a tag identification apparatus 200 according incorporating teachings of the present disclosure. The tag identification apparatus 200 includes: a tag signal receiving unit 201 and a signal processing unit 202. The tag signal receiving unit 201 is configured to receive a tag signal in a time slot.

The signal processing unit 202 is configured to determine whether a tag collision occurs in the time slot, and if it is determined that a tag collision occurs, select one tag signal from a plurality of received tag signals to identify a corresponding tag, and record a quantity of unidentified tags in the time slot. The signal processing unit 202 is further configured to: if it is determined that no tag collision occurs in a time slot, when one tag signal is received, identify a corresponding tag, and record a quantity of unidentified tags in the time slot as 0; or when no tag signal is received, record the quantity of unidentified tags in the time slot as 0.

In some embodiments, the tag identification apparatus 200 further includes a time slot quantity setting unit 203. The time slot quantity setting unit 203 is configured to add up quantities of unidentified tags recorded in all time slots in one inventory round to obtain a total quantity of unidentified tags in the inventory round, and set a quantity of time slots in a next inventory round based on the total quantity of unidentified tags. In some embodiments, the quantity of time slots in the next inventory round is set to be equal to the total quantity of unidentified tags.

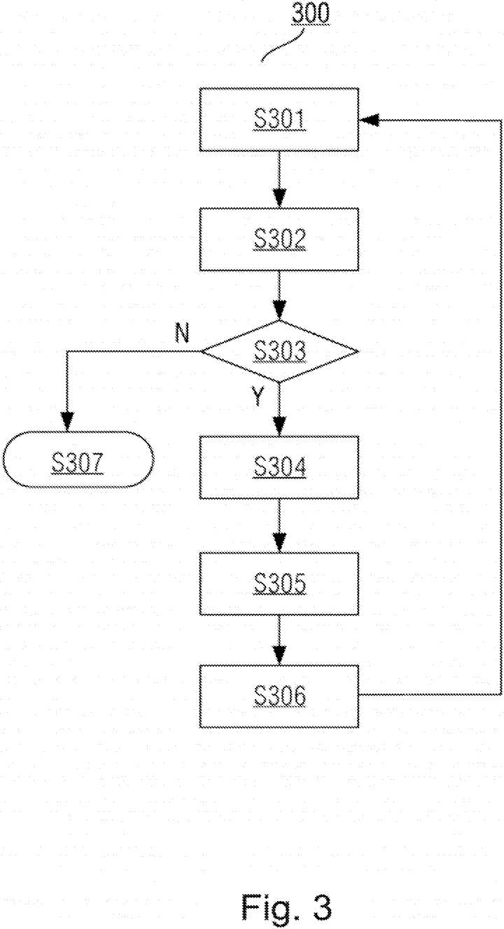

FIG. 3 is a flowchart of an exemplary process of a tag inventorying method 300 incorporating teachings of the present disclosure. In

FIG. 3, a tag signal receiving step in box S301 is first performed, that is, a plurality of tag signals are received in a time division manner based on a set quantity of time slots.

When the tag identification method 300 is performed, the steps of the method are first performed in a first inventory round. The inventory round refers to a process in which a reader receives all tag signals based on a preset quantity of time slots and then identifies all tags that can be identified. This process is called one inventory round. Then, the quantity of time slots is adjusted, a next inventory round starts, and the steps of the method are repeated.

Generally, a plurality of inventory rounds are required for tag identification until all tags can be identified. The tag identification method according to the present disclosure conforms to the EPCglobal Class 1 Generation 2 air interface protocol, and it is considered that an identified tag may not reply to a broadcast message of the reader. Then, a successful time slot processing step in S302 is performed, that is, a tag corresponding to one tag signal received in each successful time slot in which only the one tag signal is received is identified.

Next, a collision time slot determining step in S303 is performed, that is, whether there is a collision time slot in which a tag collision occurs is determined, and if there is no time slot in which a tag collision occurs, it indicates that all tags may be identified, and the method proceeds until S307 is performed, that is, the method ends. If there is a time slot in which a tag collision occurs, the following steps continue to be performed.

Then, a collision time slot processing step in box S304 is performed, that is, one tag signal is selected from a plurality of tag signals received in each collision time slot in which a tag collision occurs, to identify a corresponding tag, and a quantity of unidentified tags in the collision time slot is determined. One tag may be selected, according to a preset rule, from a plurality of tags that collide in a collision time slot for identification. Specifically, the preset rule may be, for example, randomly selecting one tag signal, selecting the tag signal with maximum energy, selecting the tag signal with minimum energy, or the like.

A corresponding rule may be set according to requirements, and details are not described herein again.

In some embodiments, identifying a corresponding tag includes: sending an acknowledgement signal for the selected tag signal, and receiving an electronic product code sent by the corresponding tag for identification. Those skilled in the art may understand that the acknowledgement signal is sent for the tag signal, that is, the one tag signal received in the successful time slot, and the electronic product code sent by the corresponding tag is received for identification.

In some embodiments, the electronic product code of the tag may be obtained, so that compatibility with the ISO18000-6C protocol can be implemented. An unselected tag is not identified, but a quantity of unidentified tags needs to be recorded. In an example, a method such as parallel tag inventorying may be used to determine a total quantity of tags that collide in a collision time slot, and a quantity of unidentified tags in a collision slot equals to the total quantity of tags that collide minus 1. The collision time slot processing step is performed, so that a quantity of unidentified tags in all collision time slots in an inventory round may be determined.

In some embodiments, a total unidentified tag quantity determining step in box S305 is performed, that is, the quantities of unidentified tags in all the collision time slots in one inventory round are added up to obtain a total quantity of unidentified tags in the inventory round. Herein, the total quantity of unidentified tags in the inventory round may be obtained by adding up the quantities of unidentified tags in all the collision time slots in the inventory round, and the total quantity of unidentified tags is a quantity of tags to be read in a next inventory round. In this way, an exact quantity of tags to be read in the next inventory round may be accurately known.

In some embodiments, a summator may be provided to add up quantities of unidentified tags in all collision time slots in one inventory round to obtain a total quantity of unidentified tags in the inventory round, and the summator may be reset at the start of a next inventory round to calculate a total quantity of unidentified tags in the next inventory round. Then, a cyclic control step in box S306 is performed. Specifically, a quantity of time slots in a next inventory round is set based on the determined total quantity of unidentified tags in the previous step, and the steps of the method 300 are performed again from step S301 based on the set quantity of time slots.

In some embodiments, the steps of the method 300 are repeated based on a set quantity of time slots in each inventory round until it is determined in step S303 that there is no time slot in which a tag collision occurs, that is, all tags may be identified, and in this case, the method 300 may be ended.

In step S306, the quantity of time slots in the next inventory round may be set to be equal to the total quantity of unidentified tags. In some embodiments, because the determined total quantity of unidentified tags is accurate, and the quantity of time slots is determined based on a quantity of tags to be identified in the next inventory round, the throughput of tag inventorying may be improved.

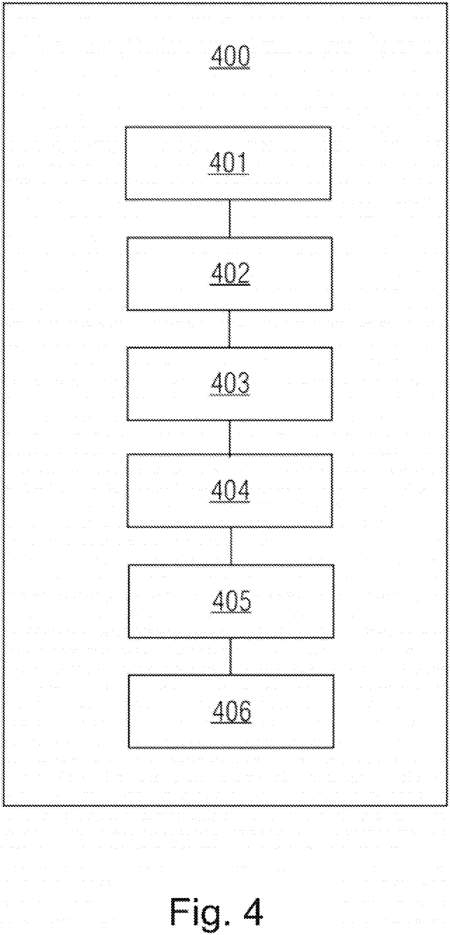

FIG. 4 is a block diagram of an exemplary configuration of a tag inventorying apparatus 400 incorporating teachings of the present disclosure. The tag identification apparatus 400 includes: a tag signal receiving unit 401, a successful time slot processing unit 402, a collision time slot determining unit 403, a collision time slot processing unit 404, a total unidentified tag quantity determining unit 405, and a cyclic control unit 406.

The tag signal receiving unit 401 is configured to receive a plurality of tag signals in a time division manner based on a set quantity of time slots.

The successful time slot processing unit 402 is configured to identify a tag corresponding to one tag signal received in each successful time slot in which only the one tag signal is received.

The collision time slot determining unit 403 is configured to determine whether there is a collision time slot in which a tag collision occurs, and if there is no collision time slot in which a tag collision occurs, end the operation, or if there is a collision time slot in which a tag collision occurs, perform operations of the following units.

The collision time slot processing unit 404 is configured to select one tag signal from a plurality of tag signals received in each collision time slot in which a tag collision occurs, to identify a corresponding tag, and determine a quantity of unidentified tags in the collision time slot.

The total unidentified tag quantity determining unit 405 is configured to add up the quantities of unidentified tags in all the collision time slots in one inventory round to obtain a total quantity of unidentified tags in the inventory round.

The cyclic control unit 405 is configured to set a quantity of time slots in a next inventory round based on the determined total quantity of unidentified tags, and perform, based on the set quantity of time slots, the operation of each unit again from the operation of the tag signal receiving unit. The cyclic control unit 405 is further configured to set the quantity of time slots in the next inventory round to be equal to the total quantity of unidentified tags.

The collision time slot processing unit 404 is further configured to select one tag signal from the plurality of received tag signals in at least one of the following manners: randomly selecting one tag signal, selecting the tag signal with maximum energy, and selecting the tag signal with minimum energy. The collision time slot processing unit 404 is further configured to send an acknowledgement signal for the selected tag signal, and receive an electronic product code sent by the corresponding tag for identification.

In some embodiments, signals received in all time slots of an inventory round may be checked, and a parallel tag inventorying method is used to detect a quantity of collision tags, so as to accurately determine a quantity of uninventoried tags.

In some embodiments, a 16-bit random number of one tag from a plurality of tags that collide is selected for acknowledgement, and a corresponding EPC of the tag may be obtained, thereby implementing compatibility with the ISO 18000 6C standard.

In some embodiments, because the quantity of allocated time slots is determined based on the accurate quantity of uninventoried tags, the throughput of tag inventorying may be improved.

The tag inventorying methods and apparatus incorporating teachings the present disclosure have a high tag inventorying speed, which is a key performance of an RFID reader. Therefore, an RFID reader using the tag inventorying method may be more advantageous in applications such as gates where huge amounts of moving tags need to be inventoried.

The tag inventorying methods and apparatus incorporating teachings of the present disclosure are compatible with the ISO 18000 6C standard, and therefore have no additional requirements for tags. It should be further noted that the tag identification apparatus 200 shown in FIG. 2 and the tag inventorying apparatus 400 shown in FIG. 4 and structures of constituent units thereof are merely exemplary, and those skilled in the art may modify the structural block diagrams in FIG. 2 and FIG. 4 according to requirements.

Details about operations and functions of various parts of the tag identification apparatus 200 shown in FIG. 2 and the tag inventorying apparatus 400 shown in FIG. 4 may be the same as or similar to related parts in the embodiments of the tag identification method 100 and the tag inventorying method 300 in the present disclosure described in conjunction with FIG. 1 and FIG. 3, and are not described herein.

As described above, with reference to FIG. 1 to FIG. 4, the embodiments of the tag identification method and apparatus and the tag inventorying method and apparatus according to the embodiments of the present disclosure are described. The above tag identification apparatus and the tag inventorying apparatus may be implemented by hardware, or may be implemented by software or a combination of hardware and software.

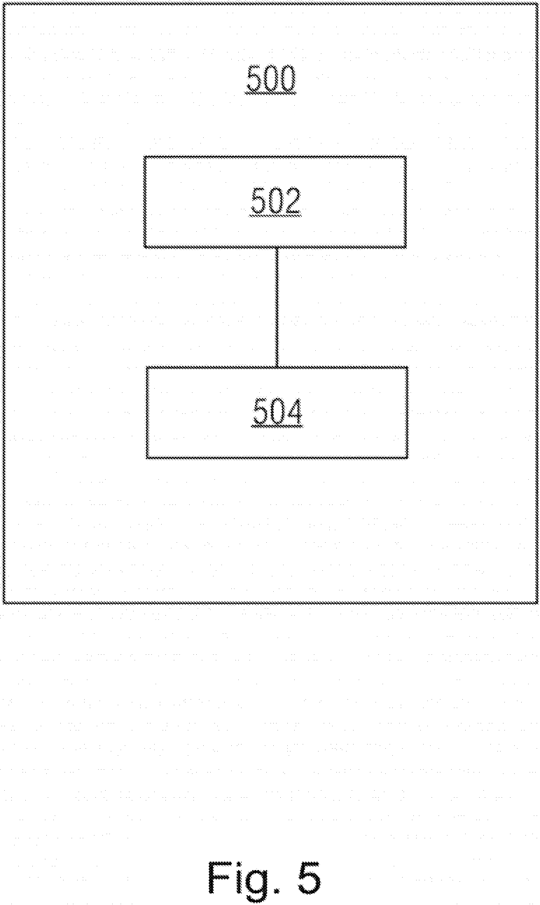

FIG. 5 is a block diagram showing a reading device 500 implementing a tag identification method and a tag inventorying method according to an embodiment of the present disclosure. According to an embodiment, the reading device 500 may include at least one processor 502, and the processor 502 executes at least one computer-readable instruction (i.e., the above element implemented in the form of software) stored or encoded in a computer-readable storage medium (i.e., a memory 504).

In some embodiments, computer-executable instructions are stored in a memory 504, and when executed, cause at least one processor 502 to implement the tag identification method or tag inventorying method described above with reference to FIG. 1 or FIG. 3, respectively. It should be understood that the computer-executable instructions stored in the memory 504, when executed, cause the at least one processor 502 to perform various operations and functions described above in conjunction with FIG. 1 to FIG. 4 in the embodiments of the present disclosure.

In some embodiments, a non-transitory machine-readable medium medium may include machine-executable instructions (i.e., the above elements implemented in the form of software) that, when executed by a machine, cause the machine to perform various operations and functions described above in conjunction with FIG. 1 to FIG. 4 in the embodiments of the present disclosure.

In some embodiments, a computer program is provided, which includes computer-executable instructions that, when executed, cause at least one processor to perform various operations and functions described above in conjunction with FIG. 1 to FIG. 4 in the embodiments of the present disclosure.

In some embodiments, a computer program product is provided, which includes computer-executable instructions that, when executed, cause at least one processor to perform various operations and functions described above in conjunction with FIG. 1 to FIG. 4 in the embodiments of the present disclosure.

Exemplary embodiments are described above in combination with the specific embodiments described in the accompanying drawings, but do not represent all the embodiments that can be implemented or fall within the scope of protection of the present disclosure. The term “exemplary” used throughout the present specification means “used as an example, an instance or an illustration”, but does not mean “preferred” or “advantageous” over the other embodiments. For the purpose of providing an understanding of the described technologies, the specific embodiments include specific details. However, the technologies can be implemented without the specific details. In some embodiments, in order to avoid obscuring the described concepts in the embodiments, commonly known structures and apparatuses are shown in the form of a block diagram.

The descriptions above of the present disclosure are provided to enable any person of ordinary skill in the art to implement or use the teachings of the present disclosure. For a person of ordinary skill in the art, various modifications made to the present disclosure are obvious and the general principles defined herein may also be applied to other variants without departing from the scope of protection of the present disclosure. Therefore, the present disclosure is not limited to the examples and designs described herein, and corresponds to the widest scope in accordance with the principles and novel features disclosed herein.

What is claimed is:

1. A tag identification method comprising:
receiving a tag signal in a time slot; and
determining whether a tag collision occurs in the time slot; and
if a tag collision occurs, selecting one tag signal from a plurality of received tag signals to identify a corresponding tag and recording a quantity of unidentified tags in the time slot.

2. The method as claimed in claim 1, wherein, if it is determined that no tag collision occurs in a time slot, and:
one tag signal is received, identifying a corresponding tag and recording a quantity of unidentified tags in the time slot as 0; or
no tag signal is received, recording the quantity of unidentified tags in the time slot as 0.

3. The method as claimed in claim 1 , further comprising:
adding up quantities of unidentified tags recorded in all time slots in one inventory round to obtain a total quantity of unidentified tags in the inventory rounder; and
setting a quantity of time slots in a next inventory round based on the total quantity of unidentified tags.

4. The method as claimed in claim 3, further comprising setting the quantity of time slots in the next inventory round to be equal to the total quantity of unidentified tags.

5. The method as claimed in claim 1 , wherein selecting one tag signal from a plurality of received tag signals to identify a corresponding tag comprises:
sending an acknowledgement signal for the selected tag signal; and
receiving an electronic product code sent by the corresponding tag for identification.

6. A tag identification apparatus comprising:
a tag signal receiving unit configured to receive a tag signal in a time slot; and
a signal processing unit configured to determine whether a tag collision occurs in the time slot, and if it is determined that a tag collision occurs, select one tag signal from a plurality of received tag signals to identify a corresponding tag, and record a quantity of unidentified tags in the time slot.

7. A tag inventorying method comprising:
receiving a plurality of tag signals in a time division manner based on a set quantity of time slots;
identifying a tag corresponding to one tag signal received in each successful time slot in which only the one tag signal is received;
determining whether there is a collision time slot in which a tag collision occurs, and if there is no collision time slot in which a tag collision occurs, ending the method, or if there is a collision time slot in which a tag collision occurs, continuing with the following:
selecting one tag signal from a plurality of tag signals received in each collision time slot in which a tag collision occurs, to identify a corresponding tag, and determining a quantity of unidentified tags in the collision time slot;
adding up the quantities of unidentified tags in all the collision time slots in one inventory round to obtain a total quantity of unidentified tags in the inventory round; and
setting a quantity of time slots in a next inventory round based on the determined total quantity of unidentified tags, and performing the steps of the method again from the tag signal receiving step based on the set quantity of time slots.

8. The method as claimed in claim 7, further comprising setting the quantity of time slots in the next inventory round to be equal to the total quantity of unidentified tags.

9. The method as claimed in claim 7, wherein selecting one tag signal from a plurality of received tag signals includes at least one of :
randomly selecting one tag signal, selecting the tag signal with maximum energy, and selecting the tag signal with minimum energy.

10. The method as claimed in claim 7, wherein identifying a corresponding tag comprises:
sending an acknowledgement signal for the selected tag signal; and
receiving an electronic product code sent by the corresponding tag for identification.

11. A tag inventorying apparatus comprising:
a tag signal receiving unit configured to receive a plurality of tag signals in a time division manner based on a set quantity of time slots;
a successful time slot processing unit configured to identify a tag corresponding to one tag signal received in each successful time slot in which only the one tag signal is received;
a collision time slot determining unit configured to determine whether there is a collision time slot in which a tag collision occurs, and if there is no collision time slot in which a tag collision occurs, end the operation, or if there is a collision time slot in which a tag collision occurs, perform operations of the following units:
a collision time slot processing unit configured to select one tag signal from a plurality of tag signals received in each collision time slot in which a tag collision occurs, to identify a corresponding tag, and determine a quantity of unidentified tags in the collision time slot;
a total unidentified tag quantity determining unit configured to add up the quantities of unidentified tags in all the collision time slots in one inventory round to obtain a total quantity of unidentified tags in the inventory round; and
a cyclic control unit configured to set a quantity of time slots in a next inventory round based on the determined total quantity of unidentified tags, and perform, based on the set quantity of time slots, the operation of each unit again from the operation of the tag signal receiving unit.

12. A reading device comprising:
a processor; and
a memory coupled to the processor, wherein the memory is configured to store instructions that, when executed by the processor, cause the processor to:
receive a tag signal in a time slot; and
determine whether a tag collision occurs in the time slot; and
if a tag collision occurs, select one tag signal from a plurality of received tag signals to identify a corresponding tag and recording a quantity of unidentified tags in the time slot.

13-15. (canceled)
